(19) United States
(12) Patent Application Publication
(10) Pub. No.: US 2006/0099391 A1
(43) Pub. Date: May 11, 2006

(54) Thermosetting resin composition, and prepreg, metal-clad laminated board and printed wiring board using the same

(76) Inventors: Kenichi Tomioka, Chikusei-shi (JP); Hiroshi Shimizu, Chikusei-shi (JP); Nobuyuki Minami, Chikusei-shi (JP); Harumi Negishi, Chikusei-shi (JP); Shinichi Kamoshida, Chikusei-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/264,052

(22) Filed: Nov. 2, 2005

(30) Foreign Application Priority Data
Nov. 5, 2004 (JP) 2004-321996
Apr. 13, 2005 (JP) 2005-115859

(51) Int. Cl. B32B 3/00; C08L 63/00

(52) U.S. Cl. 428/209; 523/400

(57) ABSTRACT

The present invention provides a thermosetting resin composition superior with respect to all characteristics of dielectric characteristics, heat resistance, moisture resistance, electrolytic corrosion resistance, adhesiveness with a copper foil, chemical resistance and flame retardancy using a halogen-free flame retardant, its use, and for example, a prepreg, laminated board and printed wiring board.

The present invention relates to: (1) a resin thermosetting resin composition comprising: (A) a phenol-modified cyanate ester oligomer obtained by reacting a cyanate compound (a) containing two or more cyanato groups in a single molecule, and (b) a phenol compound represented by the formula (I) and/or formula (II), such that a blending equivalence ratio of hydroxyl group (b)/cyanato group (a) is within a range of 0.01 to 0.3, and the monomer conversation rate of cyanate compound (a) containing two or more cyanato groups in a single molecule is 20 to 70%, (B) an epoxy resin containing two or more epoxy groups in a single molecule, and (C) at least one member selected from a metal salt of a di-substituted phosphinic acid and a phosphazene compound as a flame retardant; (2) a thermosetting resin composition comprising: components (A), (B), (C), (D) a silicone polymer containing at least one member of siloxane unit selected from a tri-functional siloxane unit represented by the formula: RSiO_{3/2} (wherein, R represents an organic group, and the R groups in the silicone polymer may be mutually the same or different) and a tetra-functional siloxane unit represented by the formula: SiO_{4/2}, having a degree of polymerization of 7,000 or less, and having one or more functional groups on its terminals that react with hydroxyl groups, and (E) an organic filler; and, a prepreg obtained by using the same, and a metal-clad laminated board and printed wiring board obtained by using the same.

### TECHNICAL FIELD

The present invention relates to a thermosetting resin composition, and a prepreg, metal-clad laminated board and printed wiring board using the same.

### BACKGROUND ART

Laminated boards primarily using epoxy resin are widely used as printed wiring boards for electronic devices. However, in response to trends toward increased pattern fineness, the establishment of surface mounting methods, increased signal propagation speeds and higher frequencies of signals used accompanying the increased mounting densities used in electronic devices, there is a strong demand for the materials of printed wiring boards to offer improved performance, and particularly low dielectric loss as well as improved heat resistance and electrolytic corrosion resistance. In addition, in response to an enhanced awareness of environmental problems in recent years, there is also a strong demand for non-halogen-based (halogen-free) printed wiring board materials that do not use halogen-based flame retardants while still maintaining satisfactory flame retardancy.

There are examples of resin compositions or laminated boards that use an epoxy resin as a curing agent and a copolymer resin composed of styrene and maleic anhydride. For example, a flexible printed wiring board is known that has for its essential component a reactive epoxy diluent and acrylonitrile-butadiene copolymer to impart flexibility, and is composed of a flexible epoxy resin and a copolymer resin composed of styrene and maleic anhydride (Japanese Unexamined Patent Publication No. S49-109476).

In addition, an epoxy resin composition is known that contains a copolymer resin, having an acid value of 280 or more that is obtained from epoxy resin, aromatic vinyl compound and maleic anhydride, and a dicyanamide (Japanese Unexamined Patent Publication No. H1-221413).

Moreover, a prepreg and electrical laminated board material are known that contains a brominated epoxy resin, copolymer resin of styrene and maleic anhydride (epoxy resin curing agent), styrene compound and solvent (Japanese Unexamined Patent Publication No. H9-25349).

A prepreg and electrical laminated board material are also known that contain an epoxy resin, copolymer resin of an aromatic vinyl compound and maleic anhydride, and a phenol compound (Japanese Unexamined Patent Publication Nos. H10-17685 and H10-17686).

A resin composition, laminated board and printed wiring board are known that contain an epoxy resin, carboxylic anhydride-based epoxy resin crosslinking agent, and allyl network-forming agent (Japanese Unexamined International Patent Publication No. H10-505376).

However, in order to accompany trends toward greater pattern fineness and the use of higher signal frequencies and so forth, various requirements are being placed on the performance of these materials, examples of which include low dielectric loss, high heat resistance, high moisture resistance and high adhesiveness with copper foil. The aforementioned performance of all of these printed wiring board materials is inadequate. In addition, these prior art printed wiring board materials use halogen-based flame retardants.

Another factor that should be considered is that, in order to accommodate the recent trend of increased pattern fineness, the diameter of through holes is tending to become smaller and the distance between hole walls is tending to become narrower. In this type of design environment surrounding printed wiring boards, the metal portions of printed wiring boards, and particularly the metal portions used as wiring, circuit patterns or electrodes and so forth, migrate over insulating materials with which they are in contact due to the action of the potential difference in environments having high moisture levels (referred to as metal migration or electrolytic corrosion). Due to this electrolytic corrosion, the insulation resistance value between electrodes and so forth decreases resulting in increased susceptibility to shorting. Consequently, the insulation reliability of the resulting printed wiring board becomes unsatisfactory. Moreover, microcracks easily form at solder boundaries when drilling through holes and so forth. Metal migration resulting from these microcracks is also considered to cause problems.

On the basis of the aforementioned problems, the object of the present invention is to provide a thermosetting resin composition superior in all characteristics consisting of dielectric characteristics, heat resistance, moisture resistance, electrolytic corrosion resistance, adhesiveness with copper foil, chemical resistance and flame retardancy using a halogen-free flame retardant, its use, and, for example, a prepreg, laminated board and printed wiring board using the same.

In order to solve the aforementioned problems, the inventors of the present invention conducted extensive studies for the purpose of providing a thermosetting resin composition that is halogen-free, has high heat resistance, adhesiveness, insulation reliability and flame retardancy, as well as superior dielectric characteristics and low moisture absorption, along with a prepreg, metal-clad laminated board and printed wiring board that uses the same, thereby leading to completion of the present invention.

Furthermore, it is clear that the present invention is not limited to that which solves all of the aforementioned problems of the prior art.

### DISCLOSURE OF THE INVENTION

The present invention relates to a thermosetting resin composition comprising:

(A) a phenol-modified cyanate ester oligomer that is the reaction product of (a) a cyanate compound containing two or more cyanato groups in a single molecule, and (b) a phenol compound containing at least one member selected from a phenol compound represented by the formula (I): 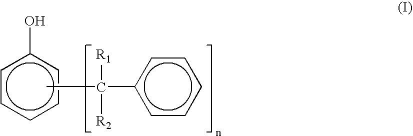
wherein R₁ and R₂ independent of each other represent a hydrogen atom or a methyl group, and may be respectively the same or different from each other, and n represents an integer of 1 or 2,
   and a phenol compound represented by the formula (II): 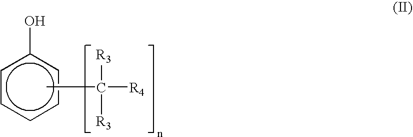
wherein R₃ independent of each other represent a hydrogen atom or a methyl group, and may be respectively the same or different from each other, R₄ represents an alkyl group selected from a methyl group, an ethyl group or a group (2a): 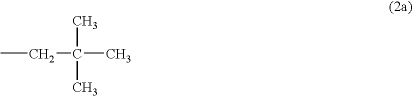
and n represents an integer of 1 or 2,
   and which is obtained by reacting such that a blending equivalence ratio of (b) hydroxyl group/(a) cyanato group is within a range of 0.01 to 0.3, and a monomer conversion rate of the cyanate compound (a) containing two or more cyanato groups in a single molecule is 20 to 70%,

(B) an epoxy resin containing two or more epoxy groups within a single molecule, and

(C) at least one member selected from a metal salt of a di-substituted phosphinic acid and a phosphazene compound. The blending equivalence ratio of (b) hydroxyl group/(a) cyanato group takes into consideration dielectric characteristics, heat resistance during moisture absorption, and varnish viscosity during varnish production.

The present invention also relates to a thermosetting resin composition comprising:

(A1) a cyanate compound containing two or more cyanato groups in a single molecule,

(B) an epoxy resin containing two or more epoxy groups within a single molecule,

(C) at least one member selected from a metal salt of a di-substituted phosphinic acid and a phosphazene compound,

(D) a silicone polymer containing at least one member of siloxane unit selected from a tri-functional siloxane unit represented by the formula:
RSiO_{3/2}
wherein R represents an organic group, and the R groups in the silicone polymer may be mutually the same or different from each other
   and a tetra-functional siloxane unit represented by the formula: SiO_{4/2}, having a degree of polymerization of 7,000 or less, and having one or more functional groups on its terminals that react with hydroxyl groups, and
   (E) an inorganic filler.

### EFFECTS OF THE INVENTION

The present invention is able to provide a thermosetting resin composition that is superior in characteristics consisting of dielectric characteristics, heat resistance, moisture resistance, electrolytic corrosion resistance, adhesiveness with copper foil, chemical resistance and flame retardancy using a halogen-free flame retardant, as well as a prepreg, laminated board and printed wiring board using the same.

### BEST MODE FOR CARRYING OUT THE INVENTION

Priority is claimed on the basis of Japanese Patent Application No. 321996/2004 and Japanese Patent Application No. 001980/2005, the contents of which are incorporated herein by reference.

There are no particular limitations on cyanato compound (a) containing two or more cyanato groups in a single molecule in (A) used in the thermosetting resin composition of the present invention, an example of which is a cyanato compound represented by the formula (III): 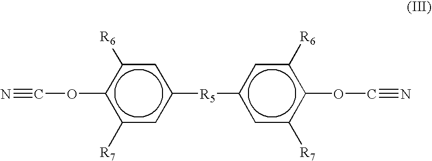
wherein R₅ represents an alkylene group having 1 to 3 carbon atoms that may or may not be substituted with a halogen, the formula (3a) or formula (3b): 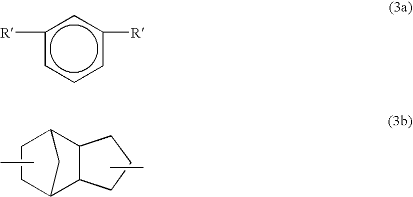
and R₆ and R₇ represent hydrogen atoms or an alkyl groups having 1 to 3 carbon atoms and R′ represent an alkyl groups having 1 to 4 carbon atoms.

Specific examples of cyanato compound (a) containing two or more cyanato groups in a single molecule in (A) used in a thermosetting resin composition of the present invention include 2,2-bis(4-cyanatophenyl) propane, bis(3,5-dimethyl-4-cyanatophenyl) methane, 2,2-bis(4-cyanatophenyl)-1,1,1,3,3,3-hexafluoropropane, α,α′-bis(4-cyanatophenyl)-m-diisopropyl benzene and a cyanate esterification product of phenol and a dicyclopentadiene copolymer, and these may be used in single or two or more members may be used as a mixture.

Specific examples of phenol compound (b) in the present invention include a phenol compound represented by the formula (I): 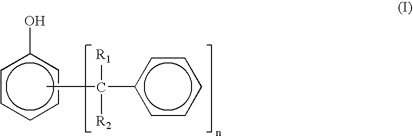
wherein R₁ and R₂ independent of each other represent a hydrogen atom or a methyl group, and may be respectively the same or different from each other, and n represents an integer of 1 or 2,
   and a phenol compound represented by the formula (II): 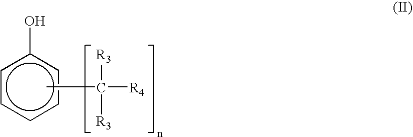
wherein R₃ independent of each other represent a hydrogen atom or a methyl group, and may be respectively the same or different from each other, R₄ represents an alkyl group selected from a methyl group, an ethyl group or a group (2a): 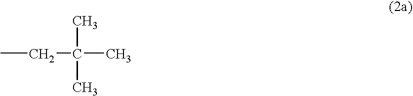
and n represents an integer of 1 or 2.

Specific examples of a phenol compound of the formula (I) include p-(α-cumyl) phenol, and mono- (or tri-) (α-methylbenzyl) phenol.

In addition, specific examples of a phenol compound of the formula (II) include p-tert-butyl phenol, 2,4- (or 2,6-) di-tert-butyl phenol, p-tert-aminophenol and p-tert-octyl phenol.

In addition, the phenol compounds of the formulae (I) and (II) can be used in single or two or more members can be used as a mixture.

A phenol-modified cyanate ester oligomer of (A) of the present invention is a phenol-modified cyanate ester oligomer in which (a) a cyanato group of a cyanate compound containing two or more cyanato groups in a single molecule, and (b) a phenolic hydroxyl group of at least one member of phenol compound selected from a phenol compound represented by the formula (I) and a phenol compound represented by the formula (II), are reacted such that a blending equivalence ratio (blending equivalence ratio of (b) hydroxyl group/(a) cyanato group) is 0.01 to 0.3 and that a monomer conversion rate of (a) the cyanate compound that contains two or more cyanato groups in a single molecule is 20 to 70%.

Moreover, in order to further improve dielectric characteristics and heat resistance during moisture absorption within the scope of the object of the present invention, after obtaining phenol-modified cyanate ester oligomer composition (A) by reacting cyanate compound (a) and phenol compound (b), phenol compound (b) can be additionally blended with 1 equivalent of the cyanato group of cyanate compound (a) used as raw material such that its phenolic hydroxyl group is within a range of 0 to 0.29 equivalents. The phenolic hydroxyl group ratio (hydroxyl group/cyanato group equivalence ratio) of phenol compound (b) to 1 equivalent of the cyanato group of cyanate compound (a) when producing the phenol-modified cyanate ester oligomer is within a range of 0.005 to 0.03, and during additional blending, the phenolic hydroxyl group ratio of phenol compound (b) to 1 equivalent of a cyanato group of cyanate compound (a) (hydroxyl group/cyanato group equivalence ratio) is preferably within a range of 0.03 to 0.10.

A phenol-modified cyanate ester oligomer (A) used in the present is the reaction product of cyanate compound (a) containing two or more cyanato groups within a single molecule, and phenol compound (b) containing at least one member selected from a phenol compound represented by the formula (I) and a phenol compound represented by formula (II), is a mixed oligomer consisting of a homo-oligomer of a cyanate compound and a modified oligomer having fewer crosslinking points than that of this homo-oligomer.

This is because cyanate compound (a) itself, containing two or more cyanato groups in a single molecule forms a cyanate ester oligomer (and mainly a homo-oligomer containing a trimer, pentamer, heptamer, nonamer or undecamer of the cyanate compound) that forms a triazine ring by a cyclization reaction. In addition, an imidocarbonation-modified oligomer is formed by addition of a phenolic hydroxyl group of phenol compound (b) represented by the formula (I) and formula (II) to a cyanato group of cyanate compound (a) containing two or more cyanato groups in a single molecule. This imidocarbonation-modified oligomer and one or more types of phenol compounds containing at least one member of phenol compound selected from the formula (I) and formula (II) are modified oligomers formed as a result of being introduced into a structure that composes the aforementioned triazine ring, namely by one or two of the three chains extending from the triazine ring being substituted by a molecule originating in a monovalent phenol compound. Accordingly, a mixed oligomer is obtained that consists of a homo-oligomer of the cyanate compound and a phenol-modified oligomer.

In the present invention, in consideration of the balance among crystallinity, and particularly crystallinity during varnish production, smoothness of the prepreg surface attributable to penetrability, and gelling time (pot life), phenol-modified cyanate ester oligomer (A) is obtained by reacting so that the monomer conversion ratio of cyanate compound (a) containing two or more cyanato groups in a single molecule is preferably 20 to 70%. Moreover, a monomer conversion rate of 45 to 65% is more preferable since it is satisfactory in terms of varnish handling ease, penetration into glass base materials as well as moisture and heat resistance and dielectric characteristics of laminated boards. More specifically, due to the high crystallinity of cyanate compound (a), in the case the cyanate compound recrystallizes in solvent when producing a varnish by dissolving the phenol-modified cyanate ester oligomer composition of the present invention in a solvent, a monomer conversion rate is preferably determined in consideration of the increase in viscosity during varnish production, decreased penetrability into a glass base material and so forth, effects on the smoothness of the prepreg surface, shortening of gelling time so as to cause a problem in terms of coating work, and the effects on the storage stability (pot life) of the varnish.

Moreover, phenol-modified cyanate ester oligomer (A) in the present invention is preferably obtained by reacting such that the number average molecular weight is 380 to 2500 in consideration of the balance among crystallinity, and particularly crystallinity during varnish production, smoothness of the prepreg surface attributable to penetrability, and gelling time (pot life) The number average molecular weight of phenol-modified cyanate ester oligomer (A) is more preferably 400 to 1600.

An epoxy resin containing two or more epoxy groups in a single molecule of (B) used in the present invention preferably contains at least one member selected from an epoxy resin derived from a dicyclopentadiene-phenol heavy addition product containing a dicyclopentadiene backbone represented by the formula (IV): 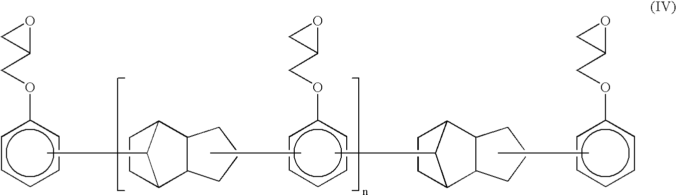
wherein n represents 0 or an integer,
   a biphenyl epoxy resin represented by the formula (V): 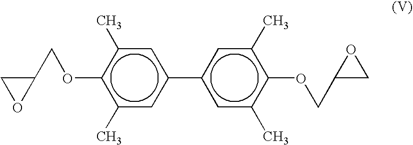
   and a biphenyl aralkyl Novolak epoxy resin represented by the formula (VI): 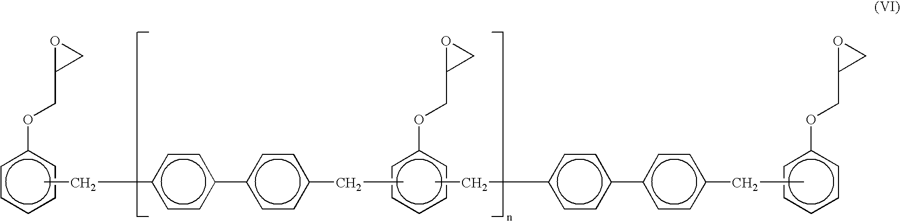
wherein n represents an integer of 1 to 10.
   In addition, these may be used in combination with other epoxy resins having two or more other epoxy groups in a single molecule. Although there are no particular limitations on the formulation ratio, in consideration of a decrease in the glass transition temperature (Tg), increase in the moisture absorption and flame retardancy, it is preferably 20% by weight or less of the total formulation ratio of epoxy resin containing two or more epoxy groups in a single molecule (B).

In addition, there are no particular limitations on the other epoxy resins having two or more epoxy groups in a single molecule used in combination with one or more types of the epoxy resins represented by the aforementioned formulae (IV) to (VI), examples of which include bisphenol A epoxy resin, cresol epoxy resin and phenol salicylaldehyde Novolak epoxy resin.

The formulation ratio of epoxy resin (B) containing two or more epoxy groups in a single molecule used in the present invention is preferably 25 to 300 parts by weight of epoxy resin (B) containing two or more epoxy groups in a single molecule based on 100 parts by weight of phenol-modified cyanate ester oligomer (A) in consideration of the balance among flame retardancy during moisture absorption, dielectric characteristics and glass transition temperature (Tg).

A metal salt of a di-substituted phosphinic acid of (C) used in the present invention is, for example, represented by the general formula (X): 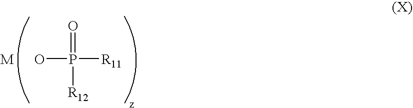
wherein R₁₁ and R₁₂ respectively and independently represent a monovalent aliphatic hydrocarbon group having 1 to 5 carbon atoms or a monovalent aromatic hydrocarbon group, M represents a metal selected from Li, Na, K, Mg, Ca, Sr, Ba, Al, Ge, Sn, Sb, Bi, Zn, Ti, Zr, Mn, Fe and Ce, and z represents an integer corresponding to the valence of M.

M of general formula (X) is preferably Al or Na since it is able to increase the phosphorous content in the compound and from the perspective of moisture resistance, and M is particularly preferably Al from the perspective of low dielectric characteristics. In addition, the aforementioned R₁₁ and R₁₂ are preferably aliphatic hydrocarbon groups having 1 to 5 carbon atoms since they are able to increase the phosphorous content in the compound, and particularly preferably methyl groups, ethyl groups or propyl groups. A particularly preferable example of a metal salt of a di-substituted phosphinic acid of flame retardant (C) is aluminum dimethylphosphinate.

A phosphazene compound of flame retardant (C) used in the present invention is a linear phosphazene represented by the general formula (XI): 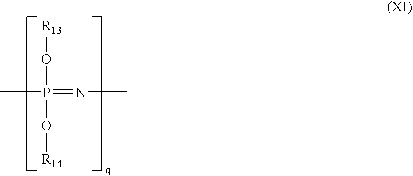
wherein R₁₃ and R₁₄ independent of each other represent a monovalent aliphatic hydrocarbon group having 1 to 5 carbon atoms or a monovalent aromatic hydrocarbon group, and q represents a natural number,
   or a cyclic phosphazene compound represented by the general formula (XII): 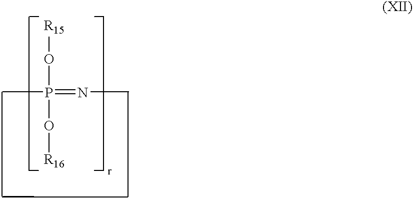
wherein R₁₅ and R₁₆ independent of each other represent a monovalent aliphatic hydrocarbon group having 1 to 5 carbon atoms or a monovalent aromatic hydrocarbon group, and r represents an integer of 3 to 8 and preferably 3 or 4.

The preferred group for R₁₃, R₁₄, R₁₅ and R₁₆ are the same as those described in the above R₁₁.

The formulation ratio of flame retardant (C) used in the present invention is preferably 10 to 150 parts by weight based on 100 parts by weight of phenol-modified cyanate ester oligomer (A) in consideration of the balance between flame retarding effects and heat resistance. The ratio between a metal salt of a di-substituted phosphinic acid and a phosphazene compound when used together is preferably from 6:4 to 7:3.

In one mode of the present invention, it is preferably a composition comprising a cyanate compound (A1) that contains two or more cyanato groups in a single molecule, an epoxy resin (B) that contains two or more epoxy groups in a single molecule, at least one member selected from a metal salt of a di-substituted phosphinic acid and a phosphazene compound (C), a silicone polymer (D) and an inorganic filler (E). The component (A1) is the same cyanate compound that contains two or more cyanato groups in a single molecule as in the component (A), however, the constitutive unit thereof is not limited to that defined for the above component (A) and may be any constitutive unit in the meaning of component (A1).

There are no particular limitations on cyanate compound (A) containing two or more cyanato groups in a single molecule in this mode.

Cyanate compound (A1) containing two or more cyanato groups in a single molecule is a reaction product of a cyanate compound (a) containing two or more cyanato groups in a single molecule, and a phenol compound (b) containing at least one member selected from a phenol compound represented by the formula (I): 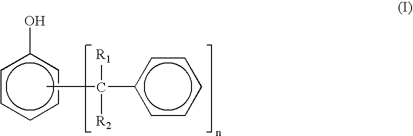
wherein R₁ and R₂ independent of each other represent a hydrogen atom or a methyl group, and may be respectively the same or different from each other, and n represents an integer of 1 to 3,
   and a phenol compound represented by the formula (II): 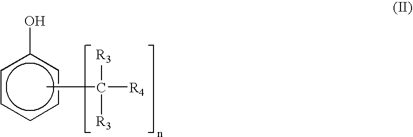
wherein, R₃ independent of each other represent a hydrogen atom or a methyl group, and may be respectively the same or different from each other, R₄ represents an alkyl group selected from a methyl group, an ethyl group or a group (2a): 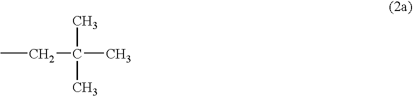
and n represents an integer of 1 or 2,
   and is preferably a phenol-modified cyanate ester oligomer reacted such that a blending equivalence ratio of (b) hydroxyl group/(a) cyanato group is within a range of 0.01 to 0.3, and a monomer conversion rate of the cyanate compound (a) containing two or more cyanato groups in a single molecule is 20 to 70%.

Among phenol compounds (b) containing at least one member selected from a phenol compound represented by formula (I) and a phenol compound represented by formula (II) of (A1) in the present invention, examples of phenol compounds represented by formula (I) include p-(α-cumyl) phenol, and mono- (or tri-) (α-methylbenzyl) phenol. Examples of phenol compounds represented by formula (II) include p-tert-butyl phenol, 2,4- (or 2,6-) di-tert-butyl phenol, p-tert-aminophenol and p-tert-octyl phenol. In addition, these phenol compounds can be used in single or two or more types can be used as a mixture.

The formulation ratio of phenol compound (b) containing at least one member selected from a phenol compound represented by formula (I) and a phenol compound represented by formula (II) of (A1) used in the present invention is such that it is reacted so that the ratio of phenolic hydroxyl groups of phenol compound (b) containing at least one member selected from a phenol compound represented by formula (I) and a phenol compound represented by formula (II) to 1 equivalent of cyanato groups of cyanate compound (a) containing two or more cyanato groups in a single molecule (hydroxyl group/cyanato group equivalence ratio) is preferably within a range of 0.01 to 0.03 in consideration of the balance among dielectric characteristics, heat resistance during moisture absorption and varnish viscosity during varnish production.

(A1) of the present invention is preferably a cyanate compound represented by the formula (III): 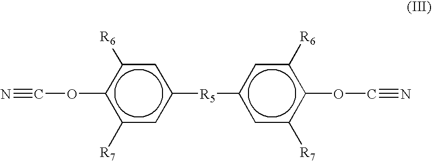
wherein R₅ represents an alkylene group having 1 to 3 carbon atoms that may or may not be substituted with a halogen, the formula (3a) or formula (3b): 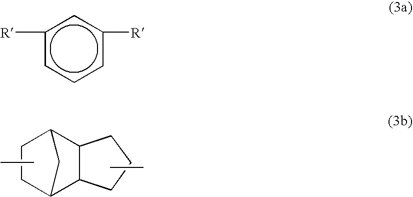
and R₆ and R₇ represent hydrogen atoms or alkyl groups having 1 to 3 carbon atoms and R′ represent alkyl groups having 1 to 4 carbon atoms.

Specific examples of (A1) of the present invention include 2,2-bis(4-cyanatophenyl) propane, bis(3,5-dimethyl-4-cyanatophenyl) methane, 2,2-bis(4-cyanatophenyl)-1,1,1,3,3,3-hexafluoropropane, α,α′-bis(4-cyanatophenyl)-m-diisopropyl benzene and a cyanate esterification product of phenol and a dicyclopentadiene copolymer, and these may be used in single or two or more types may be used as a mixture.

In addition, examples of epoxy compound (B) containing two or more epoxy groups in a single molecule and at least one member selected from a metal salt of a di-substituted phosphinic acid and a phosphazene compound of component (C) are the same as those described as above-mentioned components (B) and (C) in another mode of embodiment of the present invention.

The formulation ratio of epoxy resin (B) containing two or more epoxy groups in a single molecule used in the present invention is preferably 25 to 300 parts by weight based on 100 parts by weight of cyanate compound (A1) containing two or more cyanato groups in a single molecule in consideration of the balance among heat resistance during moisture absorption, dielectric characteristics and glass transition temperature (Tg).

The formulation ratio of component (C) consisting of at least one member selected from a metal salt of a di-substituted phosphinic acid and a phosphazene compound used in the present invention is preferably 10 to 150 parts by weight based on 100 parts by weight of cyanate compound (A1) containing two or more cyanato groups in a single molecule. The ratio between a metal salt of a di-substituted phosphinic acid and a phosphazene compound when used together is preferably from 6:4 to 7:3.

Silicon polymer (D) used in the present invention is a silicon polymer that contains at least one member of siloxane unit selected from a tri-functional siloxane unit represented by the formula: RSiO_{3/2} (wherein, R represents an organic group, and the R groups in the silicone polymer may be mutually the same or different) and a tetra-functional siloxane unit represented by the formula: SiO_{4/2}, the degree of polymerization is 7,000 or less, and there are one or more functional groups on its terminals that react with hydroxyl groups. More preferably, the lower limit of the degree of polymerization is 3, and even more preferably 3 to 1,000. Here, the degree of polymerization was calculated from the molecular weight of the polymer (in the case of a low degree of polymerization), or from the number average molecular weight as measured using a calibration curve prepared from standard polystyrene or polyethylene glycol by gel permeation chromatography. Silicone polymer (D) can also contain a bi-functional siloxane unit represented by the formula: R₂SiO_{2/2} (wherein, R represents an organic group, and R groups in the silicone polymer may be mutually the same or different from each other) in addition to the aforementioned tri-functional and tetra-functional siloxane units.

Examples of R in the formulae of the tri-functional and bi-functional siloxane units in (D) of the present invention include alkyl groups having 1 to 4 carbon atoms and phenyl groups, while examples of functional groups that react with hydroxyl groups include silanol groups, alkoxy groups having 1 to 4 carbon atoms, and acyloxy groups having 1 to 4 carbon atoms.

One to three hydrolyzable groups or OH groups may remain in the tetra-functional siloxane unit in (D) of the present invention, 1 to 2 hydrolyzable groups or OH groups may remain in the tri-functional siloxane unit, and 1 hydrolyzable group or OH group may remain in the bi-functional siloxane unit.

Specific examples of silane compounds that can be used in (D) of the present invention include tetra-functional silane compounds including tetraalkoxy silanes such as Si(OCH₃)₄, Si(OC₂H₅)₄ and Si(OC₃H₇)₄; tri-functional silane compounds including monoalkyl trialkoxy silanes such as H₃CSi (OCH₃)₃, H₅C₂Si (OCH₃)₃, H₇C₃Si (OCH₃)₃, H₉C₄Si (OCH₃)₃, H₃CSi (OC₂H₅)₃ and H₅C₂Si (OC₂H₅)₃, phenyl trialkoxy silanes such as PhSi(OCH₃)₃, PhSi(OC₂H₅)₃, PhSi(OC₃H₇)₃ and PhSi(OC₄H₉)₃ (wherein, Ph represents a phenyl group), and monoalkyl triacyloxy silanes such as (H₃CCOO)₃SiCH₃ and (H₃CCOO)₃SiC₂H₅; and bi-functional silane compounds including dialkyl dialkoxy silanes such as (HC)₂Si(OCH₃)₂, (H₅C₂)₂Si(OCH₃)₂, (H₃C)₂Si(OC₂H₅)₂, (H₅C₂)₂Si(OC₂H₅)₂, (H₃C)₂Si(OC₃H₇)₂, (H₅C₂)₂Si(OC₃H₇)₂, (H₃C)₂Si (OC₄H₉)₂, (H₅C₂)₂Si(OC₄H₉)₂ and (H₇C₃)₂Si(OC₄H₉)₂, diphenyl dialkoxy silanes such as Ph₂Si(OCH₃)₂ and Ph₂Si(OC₂H₅)₂, and dialkyl diacyloxy silanes such as (H₃CCOO)₂Si(CH₃)₂, (H₃CCOO)₂Si(C₂H₅)₂ and (H₃CCOO)₂Si(C₃H₇)₂.

The formulation ratio of silicone polymer (D) used in the present invention is preferably 0.025 to 60 parts by weight, more preferably 0.025 to 60 parts by weight based on 100 parts by weight of phenol-modified cyanate ester oligomer (A) or cyanate compound (A1) containing two or more cyanato groups in a single molecule.

There are no particular limitations on organic filler (E) used in the present invention. Specific examples of organic fillers that are used include alumina, titanium oxide, mica, silica, berrylia, zirconia, barium titanate, potassium titanate, aluminum hydroxide, calcium silicate, aluminum silicate, magnesium silicate, calcium carbonate, silicon nitride and boron nitride. These organic fillers can be used alone or two or more can be used in combination. In addition, there are no particular limitations on their form or particle size. Examples of the forms of these inorganic fillers include powders, spherical beads, fibers, whiskers and monocrystal fibers. Their particle size is normally 0.01 to 50 μm, and preferably 0.1 to 15 μm. Further, other material may be used other than the fillers listed above, such as glass, zircone, and inorganic- and organic based hollow fillers.

Organic filler (E) used in the present invention can be blended in as is, or can be used after surface treating with silicone polymer (D).

The formulation ratio of organic filler (E) used in the present invention is preferably 50 to 300 parts by weight based on 100 parts by weight of phenol-modified cyanate ester oligomer (A) or cyanate compound (A1) containing two or more cyanato groups in a single molecule in consideration of the balance to the effect of blend with dispersion of inorganic filler and appearance of prepreg.

The effects of inorganic filler (E) are further enhanced it is used after surface treating with silicone polymer (D). There are no particular limitations on the method used to treat inorganic filler (E) with silicone polymer (D), and preferable examples include a dry method in which inorganic filler (E) and silicone polymer (D) are mixed directly, and a wet method that uses a diluted treatment liquid in which inorganic filler (E) is mixed with silicone polymer (D). In addition, there are no particular limitations on the amount of silicone polymer (D) adhered to inorganic filler (E). For example, 0.01 to 20% by weight, preferably 0.05 to 10% by weight, and more preferably 0.1 to 7% by weight, of the weight of the inorganic filler can be used in consideration of the balance among the dispersivity of inorganic filler in the resin material along with the electrical insulation reliability and heat resistance.

The present invention additionally includes a polymer resin (F) containing a monomer unit represented by the formula (VII): 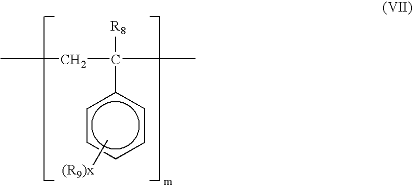
wherein, R₈ represents a hydrogen atom, halogen atom or hydrocarbon having 1 to 5 carbon atoms, R₉ respectively and independently represents a halogen atom, aliphatic hydrocarbon group having 1 to 5 carbon atoms or aromatic hydrocarbon group, x represents an integer of 0 to 3, and m represents a natural number,
   and a monomer unit represented by formula (VIII): 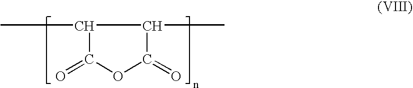
wherein n represents a natural number.
   An example of this polymer resin is a copolymer of styrene and maleic anhydride.

Examples of the monomer unit of formula (VII) include styrene, 1-methyl styrene, vinyl toluene, dimethyl styrene, chlorostyrene, and bromostyrene, and these can be used in single or two or more types can be used as a mixture. Moreover, various types of other polymerizeable components may also be polymerized in addition to the aforementioned monomer units.

Examples of various types of polymerizeable components include ethylene, propylene, butadiene, isobutyrene, acrylonitrile, vinyl compounds such as vinyl chloride and fluoroethylene, and compounds having a methacryloyl group or acryloyl group such as methacrylates such as methyl methacrylate and acrylates such as methyl acrylate.

Various types of hydroxyl group-containing compounds, amino group-containing compounds, cyanate group-containing compounds and epoxy group-containing compounds can be introduced as monomer units of formula (VIII).

The formulation ratio of the aforementioned copolymer resin (F) containing a monomer unit of formula (VII) and a monomer unit of formula (VIII) used in the present invention is preferably 10 to 200 parts by weight based on 100 parts by weight of phenol-modified cyanate ester oligomer (A) in consideration of the balance among blending effects, glass transition temperature (Tg) and moisture and heat resistance. The ratio between the monomer unit of formula (VII) and the monomer unit of formula (VIII) in the above (F) is preferably 0.8:1 to 20:1.

A curing accelerator (G) can be optionally used in the present invention. Curing accelerator (G) preferably also contains a compound having a catalytic function that accelerates the reaction between cyanate compound (a) containing two or more cyanato groups in a single molecule, and phenol compound (b) selected from a phenol compound of formula (I): 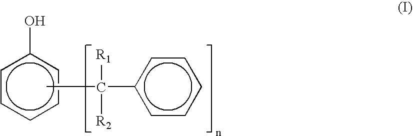
wherein R₁ and R₂ independent of each other represent a hydrogen atom or a methyl group, and may be respectively the same or different from each other, and n represents an integer of 1 or 2,
   and a phenol compound of formula (II): 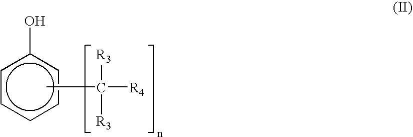
wherein R₃ independent of each other represent a hydrogen atom or a methyl group, and may be respectively the same or different from each other, R₄ represents an alkyl group selected from a methyl group, an ethyl group or a group (2a): 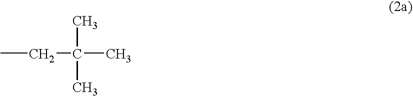
and n represents an integer of 1 or 2,
   and a compound having a catalytic function that accelerates the curing reaction of the glycidyl groups of epoxy resin (B) containing two or more epoxy groups in a single molecule.

In curing accelerator (G), all of a portion of cyanate compound (a) containing two or more cyanato groups in a single molecule and phenol compound (b) selected from a phenol compound of formula (I) and a phenol compound of formula (II) may be blended during or after synthesis of phenol-modified cyanate ester oligomer (A). More specifically, examples of a compound having this type of catalytic function that can be used as curing accelerator (G) include organometallic salts and organometallic complexes of iron, copper, zinc, cobalt, nickel, manganese and tin. The formulation ratio is preferably 0.01 to 3 parts by weight based on 100 parts by weight of phenol-modified cyanate ester oligomer (A).

In addition, in curing accelerator (G), although examples of compounds having a catalytic function that accelerates the curing reaction of glycidyl groups of epoxy resin (B) containing two or more epoxy groups in a single molecule include alkaline metal compounds, alkaline earth metal compounds, imidazole compounds and their acid addition salts, organic phosphorous compounds, secondary amines, tertiary amines and quaternary ammonium salts, imidazole compounds and their acid addition salts are most preferable in terms of catalytic function that accelerates the curing reaction of the glycidyl groups.

An imidazole compound and its acid addition salt represented by formula (IX): 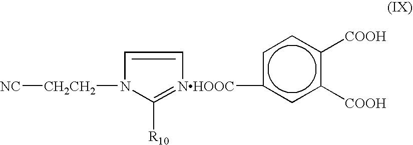
wherein R¹⁰ represents an alkyl group having 1 to 11 carbon atoms or a benzene ring
   is particularly preferable. The formulation ratio is preferably 0.05 to 3 parts by weight based on 100 parts by weight of epoxy resin (B) in consideration of the balance between catalytic effects and the storage stability of the varnish and prepreg.

In the case of combining the use of both curing accelerators, their total amount is preferably 0.1 to 5 parts by weight based on 100 parts by weight of phenol-modified cyanate ester oligomer (A) in consideration of the balance between catalytic effects and the storage stability of the varnish and prepreg. The ratio in the case of combining the use of one or more types selected from the group consisting of organometallic salts and organometallic complexes of iron, copper, zinc, cobalt, nickel, manganese and tin and an imidazole compound and its acid addition salt is preferably 2:98 to 10:90.

In a resin composition of the present invention, an antioxidant (H) can be optionally used. One member of phenol-based antioxidant or organosulfur compound-based antioxidant can be used for antioxidant (H).

Specific examples of phenol-based antioxidants include monophenol-based antioxidants such as pyrogallol, butylated hydroxyanisol and 2,6-di-t-butyl-4-methylphenol; bisphenol-based antioxidants such as 2,2′-methylene-bis-(4-methyl-6-t-butylphenol) and 4,4′-thiobis-(3-methyl-6-t-butylphenol); and polymer-type phenol-based antioxidants such as 1,3,5-trimethyl-2,4,6-tris(3,5-di-t-butyl-4-hydroxybenzyl)benzene and tetraquis-[methylene-3-(3′-5′-t-butyl-4′-hydroxyphenyl)propionate]methane. Among these phenol-based antioxidants, bisphenol-based antioxidants are particularly preferable in terms of their effects.

Specific examples of organosulfur compound-based antioxidants include dilauryl thiodipropionate and distearyl thiodipropionate.

Several types of these antioxidants may be used in combination.

The formulation ratio of antioxidant (H) of the present invention is preferably 0.1 to 20 parts by weight based on 100 parts by weight of phenol-modified cyanate ester oligomer (A) in consideration of insulating characteristics.

In a thermosetting resin composition of the present invention, other additives such as heat stabilizers, antistatic agents, plasticizers, coupling agents, pigments, dyes and colorants can be blended as desired within the scope of the object of the present invention.

There are no particular limitations on the solvent in the case of using a resin composition of the present invention in the form of a varnish. Examples of solvents include ketone-based, aromatic hydrocarbon-based, ester-based, amide-based and alcohol-based solvents. Specific examples of ketone-based solvents include acetone, methyl ethyl ketone, methyl isobutyl ketone and cyclohexanone. Specific examples of aromatic hydrocarbon-based solvents include toluene and xylene. Specific examples of ester-based solvents include methoxy ethyl acetate, ethoxy ethyl acetate, butoxy ethyl acetate and ethyl acetate. Specific examples of amide-based solvents include N-methyl pyrrolidone, formamide, N-methyl formamide and N,N-dimethyl acetoamide. Specific examples of alcohol-based solvents include methanol, ethanol, ethylene glycol, ethylene glycol monomethyl ether, ethylene glycol monoethyl ether, diethylene glycol, triethylene glycol monomethyl ether, triethylene glycol monoethyl ether, triethylene glycol, propylene glycol monomethyl ether, dipropylene glycol monomethyl ether, propylene glycol monopropyl ether and dipropylene glycol monopropyl ether. These solvents can be used in single or two or more types can be used as a mixture.

A resin composition of the present invention has superior dielectric characteristics, heat resistance, insulation reliability, electrolytic corrosion resistance and flame retardancy as a result of heat curing, and is provided for the production of metal-clad laminated boards and printed wiring boards having low moisture absorption. Namely, a prepreg is first produced by dissolving a thermosetting resin composition of the present invention in a solvent to produce a varnish followed by impregnating into a base material such as a glass fabric and drying. Next, a metal-clad laminated board is produced by laminating an arbitrary number of layers of this prepreg, layering a metal foil on one side or above and below, heating and finally press molding. Moreover, a printed wiring board can be obtained by patterning this metal-clad laminated board.

A prepreg of the present invention is obtained by, for example, impregnating or coating a thermosetting resin composition of the present invention on a base material. Next, the thermosetting resin composition is semi-cured by heating and so forth (conversion to Stage B) to produce a prepreg of the present invention. Commonly known base materials used in various types of laminated boards for electrical insulating materials can be used as a base material of the present invention. Examples of base materials include inorganic fibers such as E glass, D glass, S glass and Q glass, organic fibers such as polyimide, polyester and polytetrafluoroethylene fibers, and mixtures thereof. Although these base materials having forms such as woven fabric, non-woven fabric, ropes, chopped strand mats and surfacing mats, the material and form can be selected according to the purpose of the application and performance of the molding, and a single material or two or more types can be combined as necessary. There are no limitations on the thickness of the base material. Base materials can be used having a thickness of, for example, about 0.03 to 0.5 mm, and those that have been surface treated with a silane coupling agent and so forth or have been subject to mechanical fiber treatment are preferable in terms of heat resistance, moisture resistance and processability. The resin composition is impregnated or coated onto the base material so that the adhered amount of resin composition to the base material is 20 to 90% by weight in terms of the resin moisture content of the prepreg after drying. Subsequently, the resin composition is semi-cured (converted to stage B) by heat-drying for 1 to 30 minutes at a temperature of 100 to 200° C. to obtain a prepreg of the present invention.

A laminated board of the present invention consists of, for example, 1 to 20 layers of a prepreg of the present invention, and can be produced by laminating and molding in a constitution in which a metal foil such as copper or aluminum is disposed on one side or both sides of the layered prepreg. There are no particular limitations on the metal foil provided it is used for electrical insulating material applications. In addition, molding conditions are such that the laminated board can be molded using a multistage press, multistage vacuum press, continuous molding machine or autoclave molding machine and so forth within a range of a temperature of 100 to 250° C., pressure of 0.2 to 10 MPa, and heating time of 0.1 to 5 hours. In addition, a multilayered board can also be produced by combining a prepreg of the present invention with an inner layer wiring board followed by lamination and molding. A technique used in the production of ordinary wiring boards can be used for the circuit processing in the laminated board.

### EXAMPLES

Although the following provides a detailed explanation of the present invention through its specific examples, it should be clear that the present invention is not limited to these examples.

### Synthesis Example 1

### Preparation of Phenol-Modified Cyanate Ester Oligomer (A-1)

652.5 g of toluene, 1500 g of 2,2-bis(4-cyanatophenyl) propane (Arocy B-10, trade name, Asahi-Ciba) and 22.5 g of p-(α-cumyl) phenol (trade name, Tokyo Kasei Kogyo) were blended in a reaction vessel having a volume of 3 liters equipped with a thermometer, condenser and stirring device. After maintaining the temperature of the liquid at 120° C., 0.3 g of reaction accelerator in the form of zinc naphthenate (trade name, Wako Pure Chemical Industries) were added followed by allowing to react by heating for 4 hours (reaction concentration: 70% by weight). A phenol-modified cyanate ester oligomer was synthesized so that the conversion rate of the cyanate compound monomer was about 55%. The conversion rate of the cyanate compound monomer was confirmed by liquid chromatography (system configuration—pump: Hitachi Model L-6200, RI detector: L-3300, column: Tosoh TSKgel-G4000H, G2000H, solvent: tetrahydrofuran (THF), concentration: 1%). In addition, the number average molecular weight (Mn) of the phenol-modified cyanate ester oligomer at this time was 1430.

### Synthesis Example 2

### Synthesis of Silicone Polymer (1)

16 g of tetramethoxy silane and 24 g of methanol were placed in a 200 ml, four-neck flask equipped with a thermometer, condenser and stirring device followed by the addition of 0.21 g of acetic acid and 4.0 g of distilled water and stirring at 50° C. to synthesize a silicone polymer (D-1) in which the degree of polymerization of the siloxane unit was 20. The resulting silicone polymer had methoxy groups and silanol groups as terminal functional groups that react with hydroxyl groups.

### Synthesis Example 3

### Synthesis of Silicone Polymer (2)

6.5 g of dimethoxy dimethyl silane, 13 g of trimethoxy methyl silane and 29 g of methanol were placed in a 200 ml, four-neck flask equipped with a thermometer, condenser and stirring device followed by the addition of 0.23 g of acetic acid and 4.9 g of distilled water and stirring at 50° C. for 8 hours to synthesize a silicone polymer (D-2) in which the degree of polymerization of the siloxane unit was 18. The resulting silicone polymer had methoxy groups and silanol groups as terminal functional groups that react with hydroxyl groups.

### Synthesis Preparation Example 1

### Preparation of Silicon Polymer-Treated Inorganic Filler

10 g of dimethoxy dimethyl silane, 12 g of tetramethoxy silane and 33 g of methanol were placed in a 200 ml, four-neck flask equipped with a thermometer, condenser and stirring device followed by the addition of 0.3 g of acetic acid and 5.7 g of distilled water and stirring at 50° C. for 8 hours to synthesize a silicone polymer in which the degree of polymerization of the siloxane unit was 28. The resulting silicone polymer had methoxy groups or silanol groups as terminal functional groups that react with hydroxyl groups. A solution containing the resulting silicone polymer was placed in a 5-liter, four-neck separable flask equipped with a thermometer, condenser and stirring device, and after blending in 443 g of methyl ethyl ketone and 1102 g of inorganic filler in the form of silica (average particle size: 0.5 μm), the mixture was stirred for 1 hour at 80° C. to obtain a treatment liquid containing an inorganic filler surface-treated with silicone polymer (DE-1).

### Comparative Synthesis Example 1

### Preparation of Comparative Component (A): Phenol-Modified Cyanate Ester Oligomer (A-2)

652.5 g of toluene, 1500 g of 2,2-bis(4-cyanatophenyl) propane (Arocy B-10, trade name, Asahi-Ciba) and 22.5 g of p-(α-cumyl) phenol (trade name, Tokyo Kasei Kogyo) were blended in a reaction vessel having a volume of 3 liters equipped with a thermometer, condenser and stirring device. After maintaining the temperature of the liquid at 120° C., 0.3 g of reaction accelerator in the form of zinc naphthenate (trade name, Wako Pure Chemical Industries) were added followed by allowing to react by heating for 1 hour (reaction concentration: 70% by weight). A phenol-modified cyanate ester oligomer was synthesized so that the conversion rate of the cyanate compound monomer was about 15%. The conversion rate of the cyanate compound monomer was confirmed by liquid chromatography (system configuration—pump: Hitachi Model L-6200, RI detector: L-3300, column: Tosoh TSKgel-G4000H, G2000H, solvent: THF, concentration: 1%). In addition, the number average molecular weight (Mn) of the phenol-modified cyanate ester oligomer at this time was 250.

### Example 1

100 parts by weight of phenol-modified cyanate ester oligomer (A-1) obtained in Synthesis Example 1 as Component (A), 100 parts by weight of dicyclopentadiene epoxy resin (HP-7200L, trade name, Dainippon Ink & Chemicals) as Component (B), 45 parts by weight of polydiphenoxy phosphazene and 90 parts by weight of aluminum dimethyl phosphinate as Component (C), 50 parts by weight of COPOLYMER (EF-40, trade name, Sartomer) as Component (F) and 5 parts by weight of pyrogallol as Component (H) were blended and after dissolving in methyl ethyl ketone, 0.02 parts by weight of zinc naphthenate and 0.50 parts by weight of 2-methyl imidazole trimellitate as Component (G) were blended to obtain varnish containing 70% volatile matter.

The formulation ratios are shown in Table 1.

### Example 2

100 parts by weight of the phenol-modified cyanate ester oligomer (A-1) obtained in Synthesis Example 1 as Component (A), 100 parts by weight of biphenyl epoxy resin (YX4000, trade name, Japan Epoxy Resin) as Component (B), 30 parts by weight of polydiphenoxy phosphazene and 50 parts by weight of aluminum dimethyl phosphinate as Component (C), 100 parts by weight of copolymer (EF-40, trade name, Sartomer) as Component (F), and 5 parts by weight of 4,4-thiobis(3-methyl-6-t-butylphenol) as Component (H) were blended, and after dissolving in methyl ethyl ketone, 0.02 parts by weight of zinc naphthenate and 0.50 parts by weight of 2-methyl imidazole trimellitate as Component (G) were blended to obtain varnish containing 70% volatile matter.

### Example 3

100 parts by weight of the phenol-modified cyanate ester oligomer (A-1) obtained in Synthesis Example 1 as Component (A), 100 parts by weight of biphenyl aralkyl resin (NC-3000H, trade name, Nippon Kayaku) as Component (B), 30 parts by weight of polydiphenoxy phosphazene and 70 parts by weight of aluminum dimethyl phosphinate as Component (C), 50 parts by weight of SMA-1000 (trade name, Sartomer) as Component (F), and 2 parts by weight of 4,4-thiobis(3-methyl-6-t-butylphenol) as Component (H) were blended, and after dissolving in methyl ethyl ketone, 0.02 parts by weight of zinc naphthenate and 0.50 parts by weight of 2-methyl imidazole trimellitate as Component (G) were blended to obtain varnish containing 70% volatile matter.

### Example 4

100 parts by weight of the phenol-modified cyanate ester oligomer (A-1) obtained in Synthesis Example 1 as Component (A), 50 parts by weight of biphenyl epoxy resin (YX4000, trade name, Japan Epoxy Resin), 50 parts by weight of biphenyl aralkyl epoxy resin (NC-3000H, trade name, Nippon Kayaku) and 10 parts by weight of bisphenol A epoxy resin (DER331L, trade name, Dow Chemical) as Component (B), 45 parts by weight of polydiphenoxy phosphazene and 70 parts by weight of aluminum dimethyl phosphinate as Component (C), 100 parts by weight of SMA-1000 (trade name, Sartomer) as Component (F), and 3 parts by weight of 4,4-thiobis(3-methyl-6-t-butylphenol) as Component (H) were blended, and after dissolving in methyl ethyl ketone, 0.02 parts by weight of zinc naphthenate and 0.50 parts by weight of 2-methyl imidazole trimellitate as Component (G) were blended according to Table 1 to obtain varnish containing 70% volatile matter.

### Comparative Example 1

A varnish containing 70% volatile matter was obtained by blending in the same manner as Example 1 with the exception of using as Component (A) 100 parts by weight of Comparative Component (B-30) in the form of 2,2-bis(4-cyanatophenyl) propane (Arocy B-30, trade name, Asahi-Ciba), which although is a phenol-modified cyanate compound, is outside the scope of the present invention since the blending equivalence ratio of hydroxyl groups (b)/cyanato groups (a) is 1, and a monomer conversion rate is 0%, instead of 100 parts by weight of (A-1) of Example 1.

### Comparative Example 2

A varnish containing 70% volatile matter was obtained by blending in the same manner as Example 2 with the exception of using as Component (A) 100 parts by weight of Comparative Component (B-30) in the form of 2,2-bis(4-cyanatophenyl) propane (Arocy B-30, trade name, Asahi-Ciba) instead of 100 parts by weight of (A-1) of Example 2.

### Comparative Example 3

A varnish containing 70% volatile matter was obtained by blending in the same manner as Example 3 with the exception of using as Component (A) 100 parts by weight of Comparative Component (B-30) in the form of 2,2-bis(4-cyanatophenyl) propane (Arocy B-30, trade name, Asahi-Ciba) instead of 100 parts by weight of (A-1) of Example 3.

### Comparative Example 4

A varnish containing 70% volatile matter was obtained by blending in the same manner as Example 4 with the exception of using as Component (A) 100 parts by weight of Comparative Component (B-30) in the form of 2,2-bis(4-cyanatophenyl) propane (Arocy B-30, trade name, Asahi-Ciba) instead of 100 parts by weight of (A-1) of Example 4.

### Comparative Example 5

A varnish containing 70% volatile matter was obtained by blending in the same manner as Example 1 with the exception of using as Component (A) 100 parts by weight of Comparative Component (A) in the form of phenol-modified cyanate ester oligomer (A-2) obtained in Comparative Synthesis Example 1 instead of 100 parts by weight of (A-1) of Example 1.

The varnishes of Examples 1 to 4 and Comparative Example 1 to 5 were impregnated in a 0.2 mm thick glass fabric (basis weight: 210 g/m²), laminating the top and bottom of each with 18 μm thick copper foil, and press molding for 2 hours under conditions of 230° C. and 2.45 MPa to produce copper-clad laminated boards. Next, the copper of the copper-clad laminated boards was removed by etching to obtain laminated board test pieces.

The laminated board test pieces were evaluated for appearance, dielectric characteristics, glass transition temperature (Tg), soldering heat resistance, moisture absorption, outer layer peel strength, electrolytic corrosion resistance and flame retardancy. Furthermore, the evaluation methods are indicated below.

(1) Varnish Appearance: The appearance of the varnish after blending was evaluated visually. It was evaluated under an evaluation standard as ◯ if there was no precipitation of resin and no sedimentation of the inorganic filler, and as x if resin precipitated or inorganic filler sedimented.

Prepreg Appearance: Those prepregs that had a smooth surface were evaluated as ◯, while those that did not (including coating defects, filler aggregation and so forth) were evaluated as x.

(2) Dielectric Characteristics: Dielectric characteristics at 1 GHz are measured using the triplate line resonator method.

(3) Glass Transition Temperature (Tg): Tg is measured according to the thermo mechanical analysis (TMA) method.

(4) Soldering heat resistance: The above test pieces are cut to a size of 50 mm×50 mm to prepare test pieces for soldering heat resistence test. The test pieces for soldering heat resistence test is subjected to moisture absorption treatment for 5 hours under conditions of temperature of 121° C. and pressure of 0.22 MPa using a pressure cooker. Then, they were immersed in a 260° C. solder bath for 20 seconds. The state of this test pieces was visually observed. It was evaluated under an evaluation standard as ◯ for those test pieces that were free of blistering and measling, a Δ for those in which measling occurred, and a x for those in which blistering occurred.

(5) Moisture absorption: The above test pieces are cut to a size of 50 mm×50 mm to prepare test pieces for moisture absorption test. The test pieces for moisture absorption test are subjected to moisture absorption treatment for 5 hours under conditions of temperature of 121° C. and pressure of 0.22 MPa using a pressure cooker. The moisture absorptions are calculated by weight difference of this test pieces before and after moisture absorption treatment.

(6) Copper Foil Peel Strength: Copper lines having a width of 1 cm are formed onto the test pieces by etching. The test is conducted measuring the copper foil peel strength at a 90° angle using an autograph.

(7) Electrolytic Corrosion: The insulation resistance of 400 holes were measured over certain period of time in each sample using a test pattern having an wall distance between through hole of 350 μm. Measuring conditions are application of a voltage of 100V at 85° C. in an atmosphere of 85% RH, measurement of time is taken until conduction breakdown occurred.

(8) Flame retardancy: Flame retardancy was evaluated in compliance with the vertical burning testing method of UL94.

The evaluations and results are shown in Table 1.

TABLE 1

| | | Examples | | | | Comparative Examples | | | | |
|---|---|---|---|---|---|---|---|---|---|---|
| Item | | 1 | 2 | 3 | 4 | 1 | 2 | 3 | 4 | 5 |
| Component A | A-1 | 100 | 100 | 100 | 100 | — | — | — | — | — |
| | A-2 | — | — | — | — | — | — | — | — | 100 |
| | B-30 | — | — | — | — | 100 | 100 | 100 | 100 | — |
| Component B | HP-7200 | 100 | — | — | — | 100 | — | — | — | 100 |
| | YX-4000 | — | 100 | — | 50 | — | 100 | — | — | — |
| | NC3000H | — | — | 100 | 50 | — | — | 100 | — | — |
| | DER331L | — | — | — | 10 | — | — | — | 100 | — |
| Component C | Polydiphenoxy | 45 | 30 | 30 | 45 | 45 | 30 | 30 | 30 | 45 |
| | phosphazene | | | | | | | | | |
| | Aluminum dimethyl | 90 | 50 | 70 | 70 | 90 | 50 | 70 | 70 | 90 |
| | phosphinate | | | | | | | | | |
| Component F | EF-40 | 50 | 100 | — | — | 50 | 5 | — | — | 50 |
| | SMA4000 | — | — | 50 | 100 | — | — | 50 | 50 | — |
| Component G | Zinc naphthenate | 0.02 | 0.02 | 0.02 | 0.02 | 0.02 | 0.02 | 0.02 | 0.02 | 0.02 |
| | 2PZ-CNS | 0.50 | 0.50 | 0.50 | 0.50 | 0.50 | 0.50 | 0.50 | 0.50 | 0.50 |
| Component H | Pyrogallol | 5 | — | — | — | — | — | — | — | 5 |
| | 4,4-thiobis(3-methyl- | — | 5 | 2 | 3 | — | — | — | 5.0 | — |
| | 6-t-butylphenol) | | | | | | | | | |
| Evaluation | Varnish appearance | ◯ | ◯ | ◯ | ◯ | ◯ | ◯ | ◯ | ◯ | X |
| Results | (resin precipitation) | | | | | | | | | |
| | Relative dielectric | 3.6 | 3.6 | 3.6 | 3.6 | 3.7 | 4.0 | 3.5 | 3.8 | Unevaluable |
| | constant (1 GHz) | | | | | | | | | |
| | Dielectric tangent | 0.0060 | 0.0065 | 0.0059 | 0.0060 | 0.0070 | 0.0100 | 0.0060 | 0.0085 | |
| | (1 GHz) | | | | | | | | | |
| | Glass transition | 180 | 180 | 183 | 175 | 180 | 180 | 180 | 150 | |
| | temperature(° C.) | | | | | | | | | |
| | Soldering resistance | ◯ | ◯ | ◯ | ◯ | Δ | Δ | ◯ | X | |
| | Moisture absorption | 0.60 | 0.50 | 0.60 | 0.68 | 0.70 | 0.70 | 0.7 | 0.8 | |
| | coefficient (%) | | | | | | | | | |
| | Copper foil peel | 1.2 | 1.2 | 1.1 | 1.2 | 1.2 | 1.1 | 1.2 | 1.0 | |
| | strength (kN/m) | | | | | | | | | |
| | Electrolytic corrosion | >1000 h | >1000 h | >1000 h | >1000 h | 140 h | 200 h | 200 h | >1000 h | |
| | resistance | | | | | | | | | |
| | Flame resistance | V-0 | V-0 | V-0 | V-0 | V-0 | V-0 | V-0 | V-0 | |

As is obvious from Table 1, laminated boards obtained in Examples 1 to 4 using a specific phenol-modified cyanate ester oligomer of the present invention are superior with respect to all characteristics of dielectric characteristics, moisture and heat resistance, adhesiveness (copper foil peel strength), electrolytic corrosion resistance and flame retardancy.

On the other hand, no laminated boards obtained in Comparative Examples 1 to 5 using a phenol-modified cyanate compound outside the scope of the present invention showed superior characteristic in all of the properties, dielectric characteristics, moisture and heat resistance, adhesiveness, electrolytic corrosion resistance and flame retardancy.

### Example 5

100 parts by weight of phenol-modified cyanate ester oligomer (A-1) obtained in Synthesis Example 1 as Component (A), 100 parts by weight of dicyclopentadiene epoxy resin (HP-7200L, trade name, Dainippon Ink & Chemicals) as Component (B), 45 parts by weight of polydiphenoxy phosphazene and 90 parts by weight of aluminum dimethyl phosphinate as Component (C), 1.5 parts by weight of silicone polymer (D-1) obtained in Synthesis Example 2 as Component (D), 150 parts by weight of silica (average particle size: 0.5 μm) as Component (E), and 50 parts by weight of copolymer (EF-40, trade name, Sartomer) as Component (F) were blended in the formulation ratios shown in Table 2, and after dissolving in methyl ethyl ketone, 0.02 parts by weight of zinc naphthenate and 0.50 parts by weight of 2-methyl imidazole trimellitate as Component (G) were blended according to Table 2 to obtain varnish containing 70% by weight volatile matter.

### Example 6

100 parts by weight of phenol-modified cyanate ester oligomer (A-1) obtained in Synthesis Example 1 as Component (A), 100 parts by weight of phenyl epoxy resin (YX4000, trade name, Japan Epoxy Resin) as Component (B), 30 parts by weight of polydiphenoxy phosphazene and 50 parts by weight of aluminum dimethyl phosphinate as Component (C), 7.5 parts by weight of silicone polymer (D-2) obtained in Synthesis Example 3 as Component (D), 150 parts by weight of silica (average particle size: 0.5 μm) as Component (E), and 100 parts by weight of copolymer (EF-40, trade name, Sartomer) as Component (F) were blended in the formulation ratios shown in Table 2, and after dissolving in methyl ethyl ketone, 0.02 parts by weight of zinc naphthenate and 0.50 parts by weight of 2-methyl imidazole trimellitate as Component (G) were blended according to Table 2 to obtain varnish containing 70% by weight volatile matter.

### Example 7

100 parts by weight of phenol-modified cyanate ester oligomer (A-1) obtained in Synthesis Example 1 as Component (A), 100 parts by weight of biphenyl aralkyl epoxy resin (NC-3000H, trade name, Nippon Kayaku) as Component (B), 30 parts by weight of polydiphenoxy phosphazene and 70 parts by weight of aluminum dimethyl phosphinate as Component (C), 153 parts by weight of silicone polymer-treated inorganic filler (DE-1) obtained in Synthesis Preparation Example 1 as Components (D) and (E), and 50 parts by weight of SMA1000 (trade name, Sartomer) as Component (F) were blended in the formulation ratio is shown in Table 2, and after dissolving in methyl ethyl ketone, 0.02 parts by weight of zinc naphthenate and 0.50 parts by weight of 2-methyl imidazole trimellitate as Component (G) were blended according to Table 2 to obtain varnish containing 70% by weight volatile matter.

### Example 8

100 parts by weight of phenol-modified cyanate ester oligomer (A-1) obtained in Synthesis Example 1 as Component (A), 50 parts by weight of biphenyl epoxy resin (YX4000, trade name, Japan Epoxy Resin), 50 parts by weight of biphenyl aralkyl epoxy resin (NC-3000H, trade name, Nippon Kayaku) and 10 parts by weight of bisphenol A epoxy resin (DER331L, trade name, Dow Chemical) as Component (B), 45 parts by weight of polydiphenoxy phosphazene and 70 parts by weight of aluminum dimethyl phosphinate as Component (C), 153 parts by weight of silicone polymer-treated inorganic filler (DE-1) obtained in Synthesis Preparation Example 1 as Components (D) and (E), and 100 parts by weight of SMA1000 (trade name, Sartomer) as Component (F) were blended in the formulation ratios shown in Table 2, and after dissolving in methyl ethyl ketone, 0.02 parts by weight of zinc naphthenate and 0.50 parts by weight of 2-methyl imidazole trimellitate as Component (G) were blended according to Table 2 to obtain varnish containing 70% by weight volatile matter.

### Comparative Example 6

100 parts by weight of 2,2-bis(4-cyanatophenyl) propane (Arocy B-30, trade name, Asahi-Ciba) as Component (A), 100 parts by weight of dicyclopentadiene epoxy resin (HP-7200L, trade name, Dainippon Ink & Chemicals) as Component (B), 45 parts by weight of polydiphenoxy phosphazene and 90 parts by weight of aluminum dimethyl phosphinate as Component (C), 1.5 parts by weight of silicone polymer (D-1) obtained in Synthesis Example 2 as Component (D), 150 parts by weight of silica (average particle size: 0.5 μm) as Component (E), and 50 parts by weight of copolymer (EF-40, trade name, Sartomer) as Component (F) were blended in the formulation ratios shown in Table 2, and after dissolving in methyl ethyl ketone, 0.02 parts by weight of zinc naphthenate and 0.50 parts by weight of 2-methyl imidazole trimellitate as Component (G) were blended according to Table 2 to obtain varnish containing 70% by weight volatile matter.

### Comparative Example 7

100 parts by weight of phenol-modified cyanate ester oligomer (A-2) obtained in Comparative Synthesis Example 1 as Component (A), 100 parts by weight of dicyclopentadiene epoxy resin (HP-7200L, trade name, Dainippon Ink & Chemicals) as Component (B), 45 parts by weight of polydiphenoxy phosphazene and 90 parts by weight of aluminum dimethyl phosphinate as Component (C), 153 parts by weight of silicone polymer-treated inorganic filler (DE-1) obtained in Synthesis Preparation Example 1 as Components (D) and (E), and 50 parts by weight of copolymer (EF-40, trade name, Sartomer) as Component (F) were blended in the formulation ratios shown in Table 2, and after dissolving in methyl ethyl ketone, 0.02 parts by weight of zinc naphthenate and 0.50 parts by weight of 2-methyl imidazole trimellitate as Component (G) were blended according to Table 2 to obtain varnish containing 70% by weight volatile matter.

These varnishes of Examples 5 to 8 and Comparative Examples 6 to 7 were evaluated for appearance, dielectric characteristics, glass transition temperature (Tg), soldering heat resistance, moisture absorption, outer layer peel strength, electrolytic corrosion resistance and flame retardancy in the same manner as the previously described examples and comparative examples.

The results of those evaluations are shown in Table 2.

TABLE 2

| | | Examples | | | | Comparative Examples | |
|---|---|---|---|---|---|---|---|
| Item | | 5 | 6 | 7 | 8 | 6 | 7 |
| Component A | A-1 | 100 | 100 | 100 | 100 | — | — |
| | A-2 | — | — | — | — | — | 100 |
| | B-30 | — | — | — | — | 100 | — |
| Component B | HP-7200 | 100 | — | — | — | 100 | 100 |
| | YX-4000 | — | 100 | — | 50 | — | — |
| | NC3000H | — | — | 100 | 50 | — | — |
| | DER331L | — | — | — | 10 | — | — |
| Component C | Polydiphenoxy phosphazene | 45 | 30 | 30 | 45 | 45 | 45 |
| | Aluminum dimethyl phosphinate | 90 | 50 | 70 | 70 | 90 | 90 |
| Component D | D-1 | 1.5 | — | — | — | 1.5 | — |
| | D-2 | — | 7.5 | — | — | — | — |
| | A-187 | — | — | — | — | — | — |
| Component E | Silica | 150 | 150 | — | — | 150 | — |
| Component D + E | Silicone polymer-treated inorganic | — | — | 153 | 153 | — | 153 |
| | filler | | | | | | |
| Component F | EF-40 | 50 | 100 | — | — | 50 | 50 |
| | SMA1000 | — | — | 50 | 100 | — | — |
| Component G | Zinc naphthenate | 0.02 | 0.02 | 0.02 | 0.02 | 0.02 | 0.02 |
| | 2PZ-CNS | 0.50 | 0.50 | 0.50 | 0.50 | 0.50 | 0.50 |
| | Varnish appearance | ◯ | ◯ | ◯ | ◯ | ◯ | X |
| | (resin precipitation and filler | | | | | | |
| | sedimentation) | | | | | | |
| | Prepreg appearance | ◯ | ◯ | ◯ | ◯ | ◯ | Uncoatable |
| | Relative dielectric constant (1 GHz) | 3.6 | 3.6 | 3.6 | 3.6 | 3.7 | NG |
| | Dielectric tangent (1 GHz) | 0.0060 | 0.0065 | 0.0059 | 0.0060 | 0.0070 | NG |
| | Glass transition temperature (° C.) | 180 | 180 | 183 | 175 | 180 | NG |
| | Soldering heat resistance | ◯ | ◯ | ◯ | ◯ | X | NG |
| | Moisture absorption (%) | 0.60 | 0.50 | 0.60 | 0.68 | 0.70 | NG |
| | Copper foil peel strength (kN/m) | 1.2 | 1.2 | 1.1 | 1.2 | 1.2 | NG |
| | Electrolytic corrosion resistance | >500 h | >500 h | >500 h | >500 h | >500 h | NG |
| | Flame retardancy | V-0 | V-0 | V-0 | V-0 | V-0 | NG |

*) NG: Unevaluable due to being unable to prepare a copper-clad laminated board as a result of being unable to coat

As is obvious from Table 2, the varnishes obtained in Examples 5 to 8 according to the present invention did not demonstrate precipitation of resin or sedimentation of inorganic filler, and the surface of the prepreg had satisfactory smoothness.

On the other hand, the varnishes of Comparative Examples 7 demonstrated sedimentation of the inorganic filler and precipitation of resin. In addition, lines, bubbling and coagulation of inorganic filler occurred in the prepregs.

The laminated boards of Examples 5 to 8 are superior with respect to all characteristics of dielectric characteristics, soldering heat resistance, moisture absorption, adhesiveness (copper foil peel strength), electrolytic corrosion resistance and flame retardancy.

On the other hand, Comparative Examples 6 to 7 are inferior to the examples of the presen invention with respect to all characteristics of dielectric characteristics, soldering heat resistance, moisture absorption, adhesiveness, electrolytic corrosion resistance and flame retardancy.

### UTILIZABILITY IN INDUSTRY

A prepreg obtained by impregnating or coating a composition of the present invention on a base material, and a laminated board produced by laminating and molding the prepregs, are useful as materials for producing printed wiring boards.

A printed wiring board of the present invention is useful for forming the circuits of various types of electronic devices, such as high-speed information processing devices due to its superior dielectric characteristics, and environmentally-friendly electronic devices due to its superior flame retardancy without containing halogen compounds.

1. A thermosetting resin composition comprising:
(A) a phenol-modified cyanate ester oligomer that is the reaction product of (a) a cyanate compound containing two or more cyanato groups in a single molecule, and (b) a phenol compound containing at least one member selected from a phenol compound represented by the formula (I): 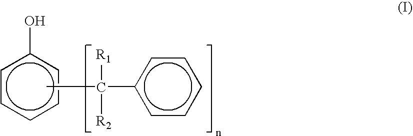
wherein R₁ and R₂ independent of each other represent a hydrogen atom or a methyl group, and may be respectively the same or different from each other, and n represents an integer of 1 or 2,
and a phenol compound represented by the formula (II): 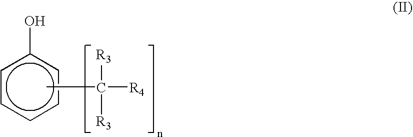
wherein R₃ independent of each other represent a hydrogen atom or a methyl group, and may be respectively the same or different from each other, R₄ represents an alkyl group selected from a methyl group, an ethyl group or a group (2a): 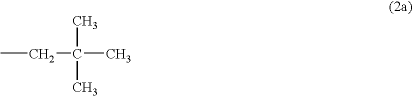
and n represents an integer of 1 or 2,
and which is obtained by reacting such that a blending equivalence ratio of (b) hydroxyl group/(a) cyanato group is within a range of 0.01 to 0.3, and a monomer conversion rate of the cyanate compound (a) containing two or more cyanato groups in a single molecule is 20 to 70%;
(B) an epoxy resin containing two or more epoxy groups within a single molecule; and,
(C) at least one member selected from a metal salt of a di-substituted phosphinic acid and a phosphazene compound as a flame retardant.

2. A thermosetting resin composition according to claim 1 wherein the phenol-modified cyanate ester oligomer of (A) is a phenol-modified cyanate ester oligomer obtained by reacting with phenol compound (b) so that the monomer conversion rate of the cyanate compound (a) containing two or more cyanate groups in a single molecule is 45 to 65%.

3. A thermosetting resin composition comprising: (A1) a cyanate compound containing two or more cyanato groups in a single molecule, (B) an epoxy resin containing two or more epoxy groups within a single molecule, (C) at least one member selected from a metal salt of a di-substituted phosphinic acid and a phosphazene compound, (D) a silicone polymer containing at least one member of siloxane unit selected from a tri-functional siloxane unit represented by the formula: RSiO_{3/2} (wherein R represents an organic group, and the R groups in the silicone polymer may be mutually the same or different) and a tetra-functional siloxane unit represented by the formula: SiO_{4/2}, having a degree of polymerization of 7,000 or less, and having one or more functional groups on its terminals that react with hydroxyl groups, and (E) an inorganic filler.

4. A thermosetting resin composition according to claim 3 wherein (A1) a cyanate compound containing two or more cyanato groups in a single molecule is a phenol-modified cyanate ester oligomer that is the reaction product of (a) a cyanate compound containing two or more cyanato groups in a single molecule, and (b) a phenol compound containing at least one member selected from a phenol compound represented by the formula (I): 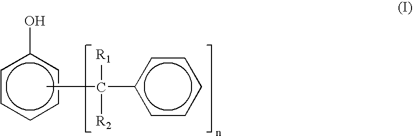
wherein R₁ and R₂ independent of each other represent a hydrogen atom or a methyl group, and may be respectively the same or different from each other, and n represents an integer of 1 to 3,
and a phenol compound represented by the formula (II): 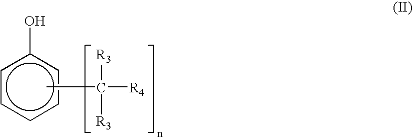
wherein R₃ independent of each other represent a hydrogen atom or a methyl group, and may be respectively the same or different from each other, R₄ represents an alkyl group selected from a methyl group, an ethyl group or a group (2a): 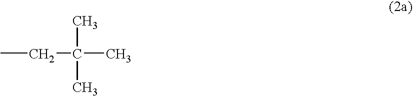
and n represents an integer of 1 or 2,
and which is reacted such that a blending equivalence ratio of (b) hydroxyl group/(a) cyanato group is within a range of 0.01 to 0.3, and the monomer conversion rate of the cyanate compound (a) containing two or more cyanato groups in a single molecule is 20 to 70%.

5. A thermosetting resin composition according to any of claims 1 to 4 wherein the number average molecular weight of the phenol-modified cyanate ester oligomer of (A) or the cyanate compound containing two or more cyanato groups in a single molecule of (A1) is 380 to 2500.

6. A thermosetting resin composition according to any of claims 1 to 4 wherein the number average molecular weight of the phenol-modified cyanate ester oligomer of (A) or the cyanate compound containing two or more cyanato groups in a single molecule of (A1) is 400 to 1600.

7. A thermosetting resin composition according to any of claims 1, 2 or 4 wherein the phenol-modified cyanate ester oligomer of (A) or the cyanate compound containing two or more cyanato groups in a single molecule of (A1) contains at least one member of cyanate compound selected from compounds represented by the formula (III): 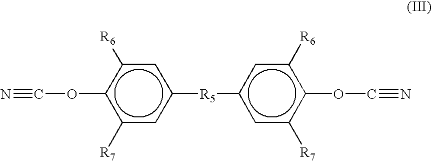
wherein R₅ represents an alkylene group having 1 to 3 carbon atoms that may or may not be substituted with a halogen, the formula (3a) or formula (3b): 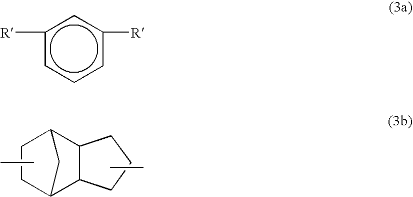
and R₆ and R₇ represent hydrogen atoms or alkyl groups having 1 to 3 carbon atoms and R′ represent alkyl groups having 1 to 4 carbon atoms.

8. A thermosetting resin composition according to any of claims 1 to 4 wherein the epoxy resin containing two or more epoxy groups in a single molecule of (B) contains at least one member selected from an epoxy resin derived from a dicyclopentadiene-phenol heavy addition product containing a dicyclopentadiene backbone represented by the formula (IV): 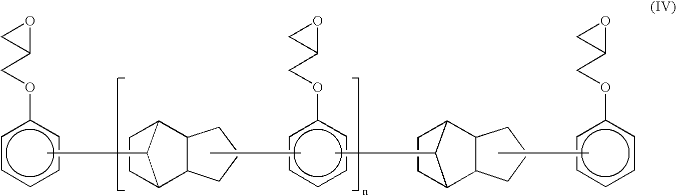
wherein n represents 0 or an integer,
a biphenyl epoxy resin represented by the formula (V): 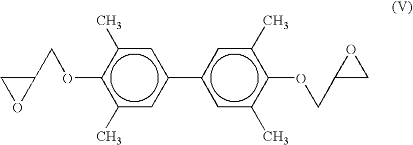
and a biphenyl aralkyl Novolak epoxy resin represented by the formula (VI): 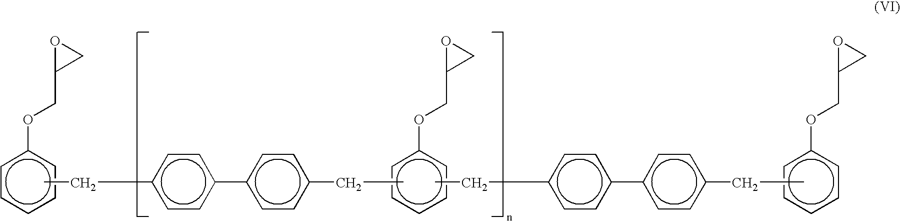
wherein n represents an integer of 1 to 10.

9. A thermosetting resin composition according to any of claims 1 to 4 that additionally contains a copolymer resin containing a monomer unit represented by the formula (VII): 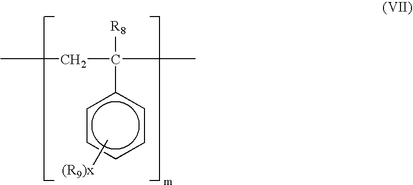
wherein R₈ represents a hydrogen atom, halogen atom or monovalent hydrocarbon group having 1 to 5 carbon atoms, R₉ respectively and independently represents a halogen atom, monovalent aliphatic hydrocarbon group having 1 to 5 carbon atoms or monovalent aromatic hydrocarbon group, x represents an integer of 0 to 3, and m represents a natural number,
and a monomer unit represented by the formula (VIII): 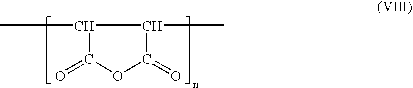
wherein n represents a natural number.

10. A thermosetting resin composition according to claim 3 or 4 that is used by surface treating the inorganic filler of (E) with the silicone polymer of (D) containing at least one member of siloxane unit selected from a tri-functional siloxane unit represented by the formula: RSiO_{3/2} (wherein, R represents an organic group, and the R groups in the silicone polymer may be mutually the same or different) and a tetra-functional siloxane unit represented by the formula: SiO_{4/2}, having a degree of polymerization of 7,000 or less, and having one or more functional groups on its terminals that react with hydroxyl groups.

11. A thermosetting resin composition according to any of claims 1 to 4 that additionally contains a copolymer resin containing a monomer unit represented by the formula (VII): 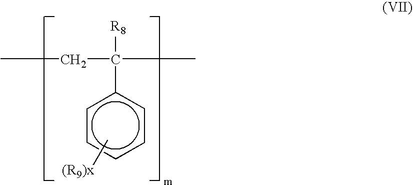
wherein R₈ represents a hydrogen atom, halogen atom or hydrocarbon having 1 to 5 carbon atoms, R₉ respectively and independently represents a halogen atom, an aliphatic hydrocarbon group having 1 to 5 carbon atoms or an aromatic hydrocarbon group, x represents an integer of 0 to 3, and m represents a natural number,
and a monomer unit represented by the formula (VIII): 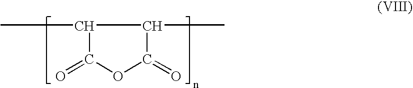
wherein n represents a natural number.

12. A thermosetting resin composition according to any of claims 1 to 4 that additionally contains as a curing accelerator (G) at least one member selected from the group consisting of organometallic salts and organometallic complexes of iron, copper, zinc, cobalt, nickel, manganese and tin, and an imidazole compound and acid addition salts thereof.

13. A thermosetting resin composition according to any of claims 1 to 4 that additionally contains as curing accelerator (G) at least one member selected from the group consisting of organometallic salts and organometallic complexes of iron, copper, zinc, cobalt, nickel, manganese and tin, and an imidazole compound and acid addition salts thereof represented by the formula (IX): 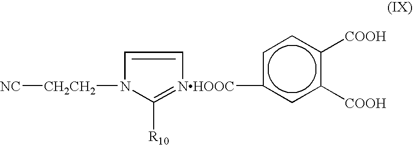
wherein R₁₀ represents an alkyl group having 1 to 11 carbon atoms or a benzene ring.

14. A thermosetting resin composition according to any of claims 1 to 4 that additionally contains as an antioxidant (H) one member of phenol-based antioxidant or organosulfur compound-based antioxidant.

15. A thermosetting resin composition according to claim 1 containing: 25 to 300 parts by weight of (B), 10 to 150 parts by weight of (C),
10 to 200 parts by weight of a copolymer resin (F) containing a monomer unit represented by the formula (VII): 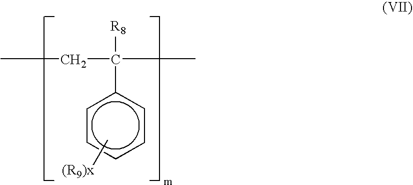
wherein R₈ represents a hydrogen atom, halogen atom or hydrocarbon having 1 to 5 carbon atoms, R₉ respectively and independently represents a halogen atom, an aliphatic hydrocarbon group having 1 to 5 carbon atoms or an aromatic hydrocarbon group, x represents an integer of 0 to 3, and m represents a natural number,
and a monomer unit represented by the formula (VIII): 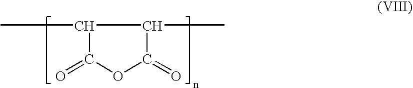
wherein n represents a natural number,
0.1 to 5 parts by weight as the total weight of at least one member selected from the group consisting of organometallic salts and organometallic complexes of iron, copper, zinc, cobalt, nickel, manganese and tin, and an imidazole compound and acid addition salts thereof as curing accelerator (G), and 0.1 to 20 parts by weight of at least one member of phenol-based antioxidant or organosulfur compound-based antioxidant as antioxidant (H) based on 100 parts by weight of (A).

16. A thermosetting resin composition according to claim 3 containing: 25 to 300 parts by weight of (B), 10 to 150 parts by weight of (C), 0.025 to 60 parts by weight of (D), 50 to 300 parts by weight of (E),
10 to 200 parts by weight of a copolymer resin (F) containing a monomer unit represented by the formula (VII): 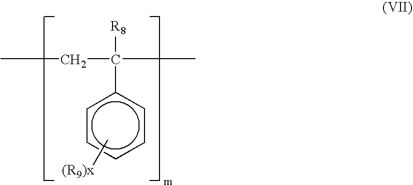
wherein R₈ represents a hydrogen atom, halogen atom or hydrocarbon having 1 to 5 carbon atoms, R₉ respectively and independently represents a halogen atom, an aliphatic hydrocarbon group having 1 to 5 carbon atoms or an aromatic hydrocarbon group, x represents an integer of 0 to 3, and m represents a natural number,
and a monomer unit represented by the formula (VIII): 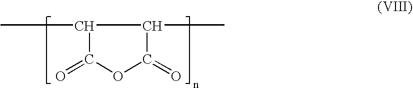
wherein n represents a natural number, and
0.1 to 5 parts by weight as the total weight of at least one member selected from the group consisting of organometallic salts and organometallic complexes of iron, copper, zinc, cobalt, nickel, manganese and tin, and an imidazole compound and acid addition salts thereof as curing accelerator (G),
based on 100 parts by weight of (A1).

17. A prepreg obtained by producing a varnish from a thermosetting resin composition according to any one of claims 1 to 4, impregnating on a base material and drying.

18. A metal-clad laminated board obtained by producing a varnish from a thermosetting resin composition according to any one of claims 1 to 4, impregnating the varnish on a base material, curing the impregnated base material till B-stage to form a prepreg, and layering and hot pressing one or a plurality of the prepreg with a metal foil on one side or metal foils on the top and bottom to form a metal-clad laminated board.

19. A wiring board obtained by producing a varnish from a thermosetting resin composition according to any one of claims 1 to 4, impregnating the varnish on a base material, curing the impregnated base material till B-stage to form a prepreg, layering and hot pressing one or a plurality of the prepreg with a metal foil on one side or metal foils on the top and bottom to form a metal-clad laminated board, and forming circuits on the metal-clad laminated board.
